(19) United States
(12) Patent Application Publication
(10) Pub. No.: US 2024/0123778 A1
(43) Pub. Date: Apr. 18, 2024

(54) MOBILITY SCOOTER TOWING SYSTEM AND METHOD

(71) Applicant: Arlynn Hansell, Cincinnati, OH (US)

(72) Inventor: Arlynn Hansell, Cincinnati, OH (US)

(21) Appl. No.: 17/967,340

(22) Filed: Oct. 17, 2022

(51) Int. Cl. B60D 1/00

(52) U.S. Cl. CPC B60D 1/00; B60D 2001/005

(57) ABSTRACT

A mobility scooter towing system and method for towing a rollator by a mobility scooter includes a tether. The tether includes a first end and a second end. The first end is secured to a mobility scooter and a coupler is attached to the second end of the tether. The coupler releasably engages with a frame of a rollator. The mobility scooter pulls the rollator using the tether.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to tow line devices and more particularly pertains to a new tow line device for a mobility scooter to pull a rollator.

### (2) Description of Related Art Including Information Disclosed Under 37 CFR 1.97 and 1.98

The prior art relates to tow line devices including a variety of devices configured for a vehicle to pull a trailer. The prior art further includes a variety of devices configured for being attached to a mobility scooter. Known prior art lacks a tow line device configured for a mobility scooter to pull a rollator.

### (h) Brief Summary of the Invention

An embodiment of the disclosure meets the needs presented above by generally comprising a tether including a first end and a second end. The first end is configured for coupling to a mobility scooter. A coupler is attached to the second end of the tether and is configured to releasably engage a frame of the rollator.

Another embodiment of the disclosure includes a method including the securing a first end of a tether to a mobility scooter. The tether has a length between 9.0 inches and 18.0 inches. A second end of the tether is then secured to a frame of a rollator so that rollator may be pulled with the mobility scooter. The second end comprises a clamp for releasably clamping onto the frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a mobility scooter towing system and method according to an embodiment of the disclosure.

FIG. 2 is a rear view of an embodiment of the disclosure.

FIG. 3 is a side view of an embodiment of the disclosure.

FIG. 4 is an in-use view of an embodiment of the disclosure.

FIG. 5 is an exploded view of an embodiment of the disclosure.

FIG. 6 is an in-use view of an embodiment of the disclosure.

FIG. 7 is a cross-sectional view of an embodiment of the disclosure taken from FIG. 6 of Line 7-7.

### (j) DETAILED DESCRIPTION OF THE INVENTION

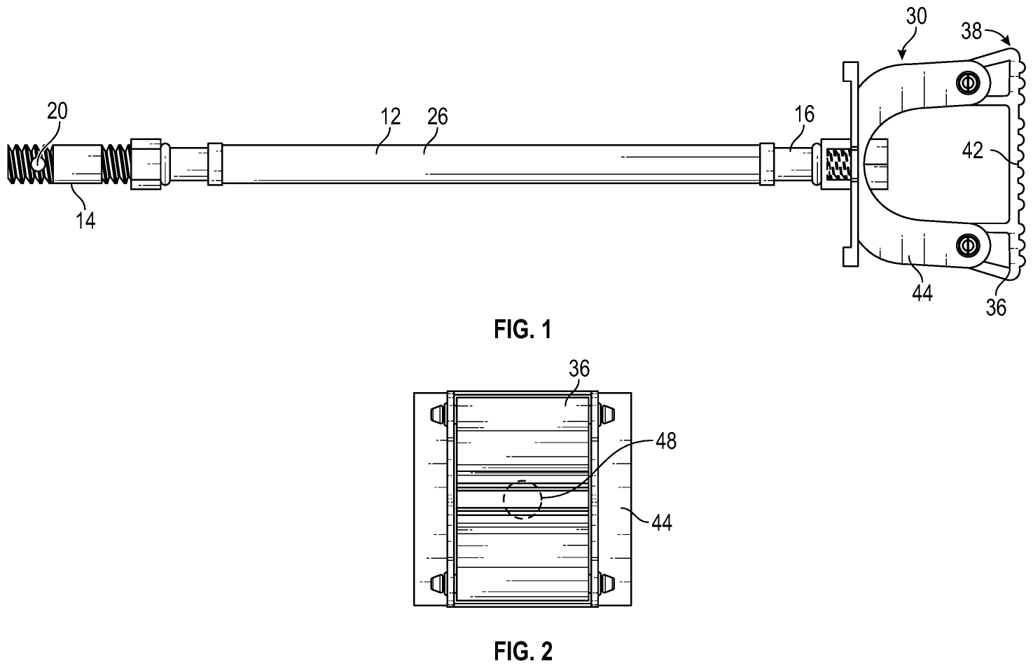

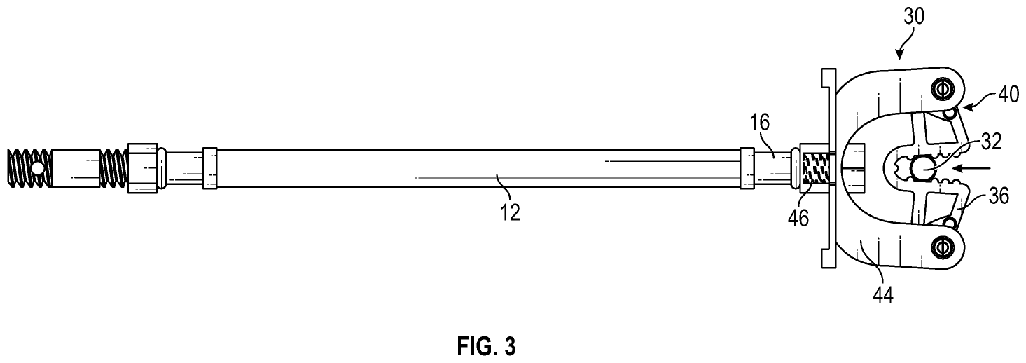

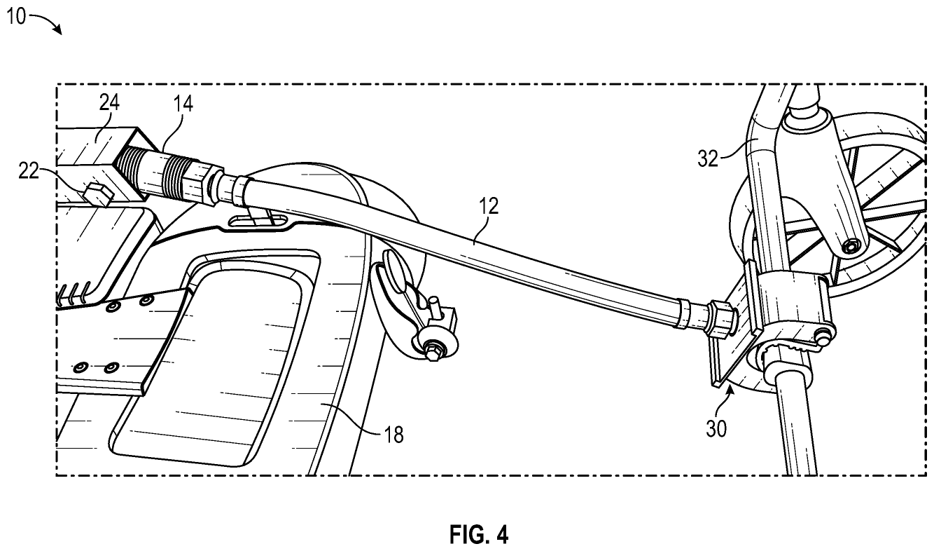

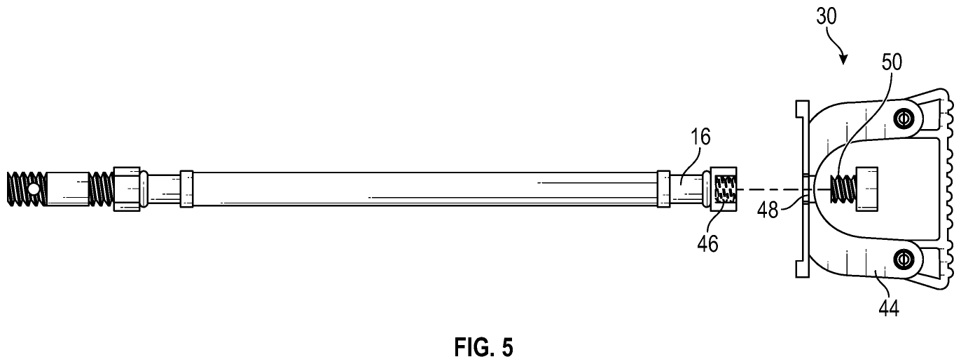

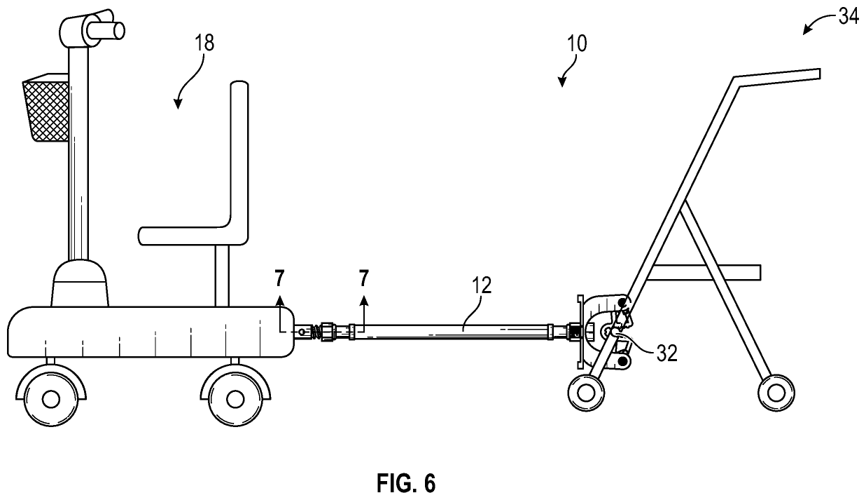

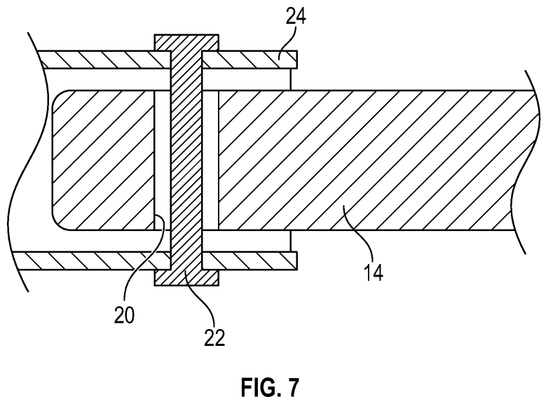

With reference now to the drawings, and in particular to FIGS. 1 through 7 thereof, a new tow line device embodying the principles and concepts of an embodiment of the disclosure and generally designated by the reference numeral 10 will be described.

As best illustrated in FIGS. 1 through 7, the mobility scooter towing system 10 generally comprises a tether 12 having a first end 14 and a second end 16. The first end 14 is configured for coupling to a mobility scooter 18. The mobility scooter 18 is conventional and electrically powered. The first end 14 has an aperture 20 extending therethrough and is configured for receiving an engagement member 22 of a receiving port 24 of the mobility scooter 18. The engagement member 22 may comprise a hitch pin and the receiving port 24 a hitch pipe. The receiving port 24 receives the first end 14 of the tether 12 and the engagement member 22 is inserted through the aperture 20 to secure the first end 14 within the receiving port 24. The tether 12 has a length between 9.0 inches and 18.0 inches and typically has a length between 12.0 inches and 16.0 inches. The tether 12 may be comprised of a braided material 26, such as is used with flexible water conduits and being semi-rigid such that the tether 12 is bendable. The second end 16 of the tether 12 may be stored by attachment to the mobility scooter 18 when the tether is not being used.

A coupler 30 is attached to the second end 16 of the tether 12 and is configured to releasably engage a frame 32 of the rollator 34. The rollator 34 is conventional and is also referred to as a wheeled walker used to support a person while walking. The coupler 30, in one embodiment, may comprise a clamp 36 for releasably clamping onto the frame 32. The clamp 36 may be of the type utilized for holding tools wherein the handle of the tool is received by, and frictionally held by, the clamp 36. This may include a pair of spaced, fixed members that compress when receiving a handle or, as shown in the Figures, the clamp 36 may include an elastomeric panel that bends around the handle while the end of the elastomeric panel rotate relative to a pair of fixed arms. In the embodiment herein, the elastomeric panel bends around and receives the frame 32 as the ends of the elastomeric panel rotate toward each other to envelope the frame to a closed position 40 which biases the frame toward the tether 12. Pulling the frame 32 away from the tether will rotate the ends of the elastomeric panel in the opposite direction to an open position 38 which releases the frame 32. Protrusions 42 provide greater grip between claim 36 and the frame 32 of the rollator 34. The clamp 36 has a base 44 being engaged with the second end 16 of the tether 12. The second end 16 is a threaded receiver 46. The base 44 has a hole 48 extending therethrough and which is alignable with the threaded receiver 46 of the second end 16. A bolt 50 extends through the hole 48 and into the threaded receiver 46 to secure the clamp 36 to the tether 12.

In use, the first end 14 of the tether 12 is secured to the mobility scooter 18. The second end 16 of the tether 12 is thereafter secured to the frame 32 of the rollator 34 with the clamp 36 being releasably attached onto the frame 32. The mobility scooter 18 pulls the rollator 34 by the tether 12 as the mobility scooter 18 moves in a forward direction. Thus, the user will have the rollator 34 close by when they choose to switch from the mobility scooter 18 to the rollator 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobility scooter towing system configured for towing a rollator with a mobility scooter, said mobility scooter towing system comprising:
a tether including a first end and a second end, said first end being configured for coupling to a mobility scooter;
a coupler being attached to said second end of said tether and being configured to releasably engage a frame of the rollator.

2. The mobility scooter towing system of claim 1, further comprising said first end including an aperture extending therethrough and receiving an engagement member of a receiving port of a mobility scooter.

3. The mobility scooter towing system of claim 1, further comprising said tether having a length between 9.0 inches and 18.0 inches.

4. The mobility scooter towing system of claim 1, further comprising said tether being comprised of a braided material.

5. The mobility scooter towing system of claim 1, further said coupler comprising a clamp for releasably clamping onto the frame.

6. A mobility scooter towing system configured for towing a rollator with a mobility scooter, said mobility scooter towing system comprising:
a tether including a first end and a second end, said first end being configured for coupling to a mobility scooter, said first end including an aperture extending therethrough and receiving an engagement member of a receiving port of a mobility scooter, said tether having a length between 9.0 inches and 18.0 inches, said tether being comprised of a braided material; and
a coupler being attached to said second end of said tether and being configured to releasably engage a frame of the rollator, said coupler comprising a clamp for releasably clamping onto the frame.

7. A method of towing a rollator including the steps of:
securing a first end of a tether to a mobility scooter, said tether having a length between 9.0 inches and 18.0 inches;
securing a second end of said tether to a frame of the rollator, said second end comprising a clamp for releasably clamping onto the frame; and
pulling the rollator with the mobility scooter.
